(19) United States
(12) Patent Application Publication
(10) Pub. No.: US 2024/0094498 A1
(43) Pub. Date: Mar. 21, 2024

(54) OPTICAL ELEMENT DRIVING MECHANISM

(71) Applicant: TDK TAIWAN CORP., Taoyuan City (TW)

(72) Inventors: Po-Xiang ZHUANG, Taoyuan City (TW); Chen-Hung CHAO, Taoyuan City (TW); Wei-Jhe SHEN, Taoyuan City (TW); Shou-Jen LIU, Taoyuan City (TW); Kun-Shih LIN, Taoyuan City (TW); Yi-Ho CHEN, Taoyuan City (TW)

(21) Appl. No.: 18/467,236

(22) Filed: Sep. 14, 2023

Related U.S. Application Data
(60) Provisional application No. 63/406,916, filed on Sep. 15, 2022.

(51) Int. Cl. G02B 7/08; H01F 7/08

(52) U.S. Cl. CPC G02B 7/08; H01F 7/081

(57) ABSTRACT

An optical element driving mechanism is provided. The optical element driving mechanism includes a movable portion used for connecting an optical element, a fixed portion, and a driving assembly used for driving the movable portion to move relative to the fixed portion. The movable portion is movable relative to the fixed portion.

### CROSS REFERENCE TO RELATED APPLICATIONS

This application claims priority of U.S. Provisional Application No. 63/406,916, filed on Sep. 15, 2022, the entirety of which is incorporated by reference herein.

### BACKGROUND OF THE INVENTION

### Field of the Invention

The present disclosure relates to an optical element driving mechanism.

### Description of the Related Art

As technology has developed, it has become more common to include image-capturing and video-recording functions into many types of modern electronic devices, such as smartphones and digital cameras. These electronic devices are used more and more often, and new models have been developed that are convenient, thin, and lightweight, offering more choice to consumers.

Electronic devices that have image-capturing or video-recording functions normally include an optical system to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY OF THE INVENTION

An optical element driving mechanism is provided. The optical element driving mechanism includes a movable portion used for connecting an optical element, a fixed portion, and a driving assembly used for driving the movable portion to move relative to the fixed portion. The movable portion is movable relative to the fixed portion.

In some embodiments, the optical element driving mechanism further includes a guiding assembly and a magnetically permeable assembly. The driving assembly includes a plurality of magnetic elements and a plurality of driving coils. The guiding assembly includes at least one guiding element. The magnetically permeable assembly includes at least one magnetically permeable element. The guiding assembly is magnetically permeable. The magnetically permeable assembly is magnetically permeable.

In some embodiments, a sum of a number of the guiding elements and a number of the magnetically permeable elements is identical to a number of the magnetic elements. The sum of the numbers of the guiding elements and the numbers of the magnetically permeable elements is equal to a number of the driving coils.

In some embodiments, the at least one guiding element includes a first guiding element and a second guiding element. The at least one magnetically permeable element includes a first magnetically permeable element and a second magnetically permeable element. The fixed portion includes a bottom. The bottom is polygonal. The bottom includes a first corner, a second corner, a third corner, and a fourth corner. The first corner and the third corner are opposite. The second corner and the fourth corner are opposite. The first guiding element is disposed on the first corner. The first magnetically permeable element is disposed on the second corner. The second guiding element is disposed on the third corner. The second magnetically permeable element is disposed on the fourth corner.

In some embodiments, the first guiding element and the second guiding element are columnar. The first magnetically permeable element and the second magnetically permeable element are plate-shaped. The first guiding element and the second guiding element extend in a first direction. A normal vector of the first magnetically permeable element is perpendicular to the first direction. A normal vector of the second magnetically permeable element is perpendicular to the first direction.

In some embodiments, the first guiding element and the second guiding element are in direct contact with the movable portion. The first magnetically permeable element and the second magnetically permeable element are separated from the movable portion.

In some embodiments, the magnetic elements include a first magnetic element. The driving coils include a first driving coil. The first magnetic element corresponds to the first driving coil. The first magnetic element includes a first surface and a second surface. The first surface faces the first magnetically permeable element. The second surface faces the first driving coil. The optical element driving mechanism further includes a third magnetically permeable element disposed on the first magnetic element. The first surface is exposed from the third magnetically permeable element. The second surface is exposed from the third magnetically permeable element.

In some embodiments, the first magnetic element and the first magnetically permeable element at least partially overlap each other when viewed in a direction perpendicular to the second surface.

In some embodiments, the first magnetic element further includes a third surface, a fourth surface, a fifth surface, and a sixth surface. The third surface is opposite to the first surface. The fourth surface is opposite to the second surface. The fifth surface is adjacent to the first surface, the second surface, the third surface, and the fourth surface. The sixth surface is adjacent to the first surface, the second surface, the third surface, and the fourth surface. The fifth surface is opposite to the sixth surface. The third magnetically permeable element is disposed on the third surface. The third magnetically permeable element is disposed on the fourth surface. The third magnetically permeable element is disposed on the fifth surface. The third magnetically permeable element is disposed on the sixth surface.

In some embodiments, at least a portion of the movable portion is disposed between the third magnetically permeable element and the first magnetic element.

In some embodiments, the optical element driving mechanism further includes a circuit element, a first bonding element, and a second bonding element. The driving coils are disposed on the circuit element through the first bonding element. The driving coils are disposed on the circuit element through the second bonding element. The first bonding element is in direct contact with the second bonding element. The first bonding element and the second bonding element include different materials.

In some embodiments, the circuit element includes an opening. The first bonding element is not disposed on the opening. The second bonding element is not disposed on the opening.

In some embodiments, the first driving coil includes a first coil surface, a second coil surface, a third coil surface, and a fourth coil surface. The first coil surface faces the circuit element. The second coil surface is adjacent to the first coil surface. The first bonding element covers at least a portion of the first coil surface. The second bonding element covers at least a portion of the second coil surface. The third coil surface is opposite to the first coil surface. The second coil surface is opposite to the fourth coil surface.

In some embodiments, the first bonding element and the second bonding element are not disposed on the third coil surface. The first bonding element and the second bonding element are not disposed on the fourth coil surface.

In some embodiments, the first driving coil includes a leading wire. The circuit element includes a conductive pad. The leading wire connects to the conductive pad. The second bonding element covers at least a portion of the leading wire. The second bonding element covers at least a portion of the conductive pad.

In some embodiments, the first bonding element does not cover the leading wire. The first bonding element does not cover the conductive pad.

In some embodiments, the magnetic elements further include a second magnetic element, a third magnetic element, and a fourth magnetic element disposed on the movable portion. The driving coils further include a second driving coil, a third driving coil and a fourth driving coil disposed on the fixed portion. The second magnetic element corresponds to the second driving coil. The third magnetic element corresponds to the third driving coil. The fourth magnetic element corresponds to the fourth driving coil.

In some embodiments, a first magnetic force is generated between the first magnetic element and the first magnetically permeable element and applied on the movable portion. A second magnetic force is generated between the second magnetic element and the first guiding element and applied on the movable portion. A third magnetic force is generated between the third magnetic element and the second magnetically permeable element and applied on the movable portion. A fourth magnetic force is generated between the fourth magnetic element and the second guiding element and applied on the movable portion. The first magnetic force, the second magnetic force, the third magnetic force, and the fourth magnetic force have different directions.

In some embodiments, directions of the first magnetic force and the third magnetic force are opposite. Directions of the second magnetic force and the fourth magnetic force are opposite.

In some embodiments, the first magnetic force generates a first torque to the movable portion. The second magnetic force generates a second torque to the movable portion. The third magnetic force generates a third torque to the movable portion. The fourth magnetic force generates a fourth torque to the movable portion. Directions of the first torque, the second torque, the third torque, and the fourth torque are identical.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of an optical element driving mechanism.

FIG. 1B is an exploded view of the optical element driving mechanism.

FIG. 1C is a side view of the optical element driving mechanism.

FIG. 1D is a cross-sectional view illustrated along the line A-A in FIG. 1C.

FIG. 2A and FIG. 2B are top views of some elements of the optical element driving mechanism.

FIG. 3A, FIG. 3B, and FIG. 3C are schematic views of some elements of the optical element driving mechanism viewed in different directions

FIG. 4 is a schematic view of some elements of the optical element driving mechanism.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

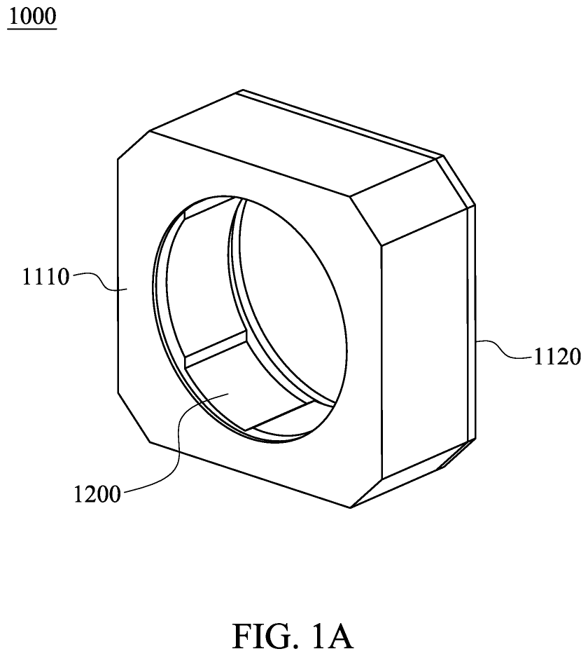

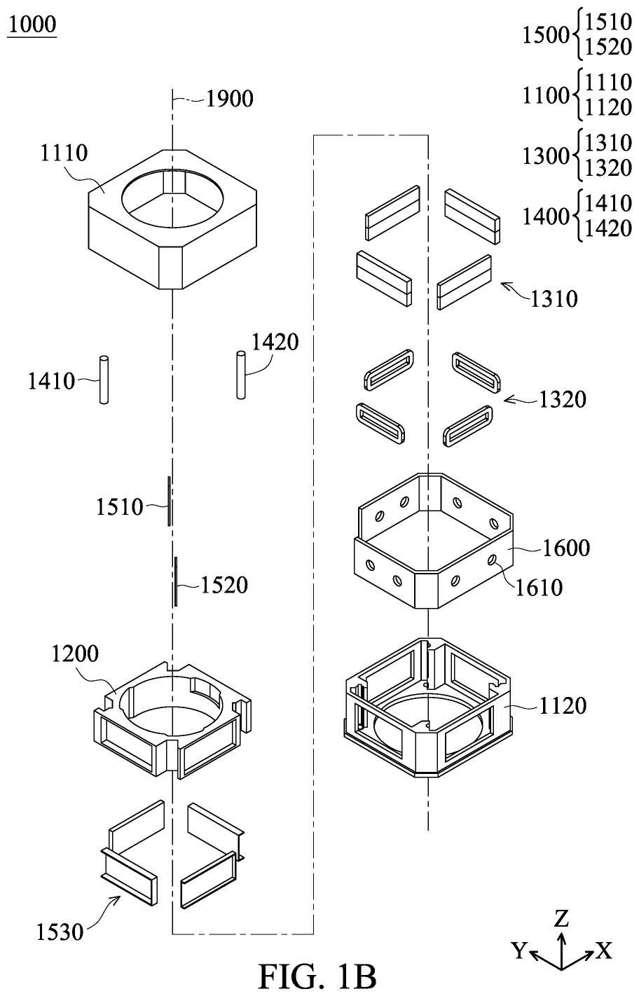

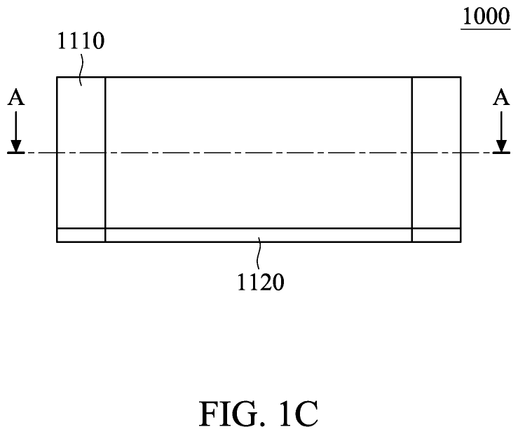

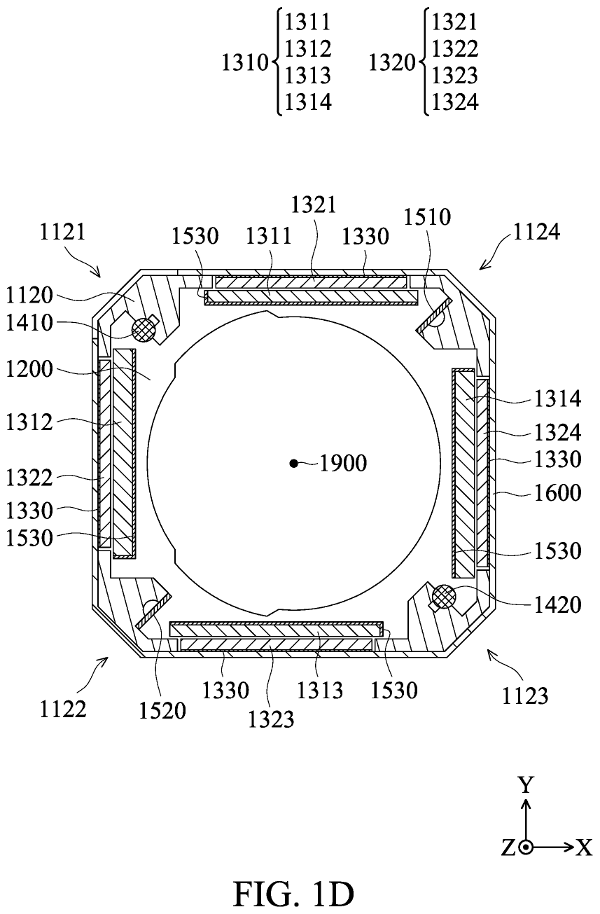

Embodiments of the present disclosure provide an optical element driving mechanism for driving a movable portion moving relative to the fixed portion. For example, FIG. 1A is a schematic view of an optical element driving mechanism 1000. FIG. 1B is an exploded view of the optical element driving mechanism 1000. FIG. 1C is a side view of the optical element driving mechanism 1000. FIG. 1D is a cross-sectional view illustrated along the line A-A in FIG. 1C. As shown in FIG. 1A to FIG. 1D, the optical element driving mechanism 1000 may mainly include a fixed portion 1100 (which includes a case 1110 and a bottom 1120), a movable portion 1200, a driving assembly 1300 (which includes a magnetic element 1310 and a driving coil 1320), a guiding assembly 1400 (which includes a first guiding element 1410 and a second guiding element 1420), a magnetically permeable assembly 1500 (which includes a first magnetically permeable element 1510 and a second magnetically permeable element 1520) and a circuit element 1600 arranged along a main axis 1900.

The case 1110 and the bottom 1120 may be combined to form a shell of the optical element driving mechanism 1000 to protect other elements disposed therein. For example, the bottom 1120 may be affixed on the case 1110. It should be noted that openings are formed on the case 1110 and the bottom 1120 with their centers corresponding to the main axis 1900 and an image sensor (not shown) disposed outside the optical element driving mechanism 1000. Therefore, the optical element disposed in the optical element driving mechanism 1000 may perform focus with the image sensor along the main axis 1900.

In some embodiments, the movable portion 1200 may be disposed in the fixed portion 1100, may be polygonal, and may be used for disposing an optical element (not shown). The movable portion 1200 may have a through hole, and the optical element may be disposed in the through hole. The optical element may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the magnetic element 1310 may include a first magnetic element 1311, a second magnetic element 1312, a third magnetic element 1313, and a fourth magnetic element 1314, and the driving coil 1320 may include a first driving coil 1321, a second driving coil 1322, a third driving coil 1323, and a fourth driving coil 1324 used for driving the movable portion 1200 to move relative to the fixed portion 1100. In some embodiments, the first magnetic element 1311, the second magnetic element 1312, the third magnetic element 1313, and the fourth magnetic element 1314 may include magnets and may be disposed on the movable portion 1200 to corresponding to the first driving coil 1321, the second driving coil 1322, the third driving coil 1323, and the fourth driving coil 1324 disposed on the fixed portion 1100, respectively. The first magnetic element 1311, the second magnetic element 1312, the third magnetic element 1313, and the fourth magnetic element 1314 may respectively generate electromagnetic forces with the first driving coil 1321, the second driving coil 1322, the third driving coil 1323, and the fourth driving coil 1324 to drive the movable portion 1200 moving relative to the fixed portion 1100 for performing auto focus (AF). In some embodiments, the magnetic element 1310 may be disposed on the fixed portion 1100, and the driving coil 1320 may be disposed on the movable portion 1200, depending on design requirement.

In some embodiments, the guiding assembly 1400 and the magnetically permeable assembly 1500 may include magnetically permeable material to attract the magnetic element 1310 for generating a magnetic force. In some embodiments, a third magnetically permeable element 1530 may be disposed on the magnetic element 1310 to control the magnetic field generated by the magnetic element 1310. In some embodiments, the movable portion 1200 may be at least partially disposed between the third magnetically permeable element 1530 and the magnetic element 1310 to prevent the third magnetically permeable element 1530 from directly attracted on the magnetic element 1310.

In some embodiments, the guiding assembly 1400 may be disposed on the fixed portion 1100, such as may be disposed on the bottom 1120, and may be in direct contact with the bottom 1120 to guide the movement direction of the movable portion 1200 relative to the fixed portion 1100. For example, the first guiding element 1410 and the second guiding element 1420 may be columnar and may extend in a direction parallel to the main axis 1900 (e.g. the Z direction). Therefore, when the movable portion 1200 is driven by the driving assembly 1300 to move relative to the fixed portion 1100, the movement direction of the movable portion 1200 may be defined by the guiding assembly 1400, such as moving on the Z direction.

In some embodiments, the magnetically permeable assembly 1500 may be disposed on the fixed portion 1100 (e.g. the bottom 1120) and may be separated from the movable portion 1200 to generate a magnetic field with the magnetic element 1310 disposed on the movable portion 1200, so a force having a specific direction is applied on the movable portion 1200, such as a normal force relative to the guiding assembly 1400. Therefore, the movable portion 1200 may be disposed on the guiding assembly 1400 by frictional contact to move relative to the fixed portion 1100. In some embodiments, the first magnetically permeable element 1510 and the second magnetically permeable element 1520 may be plate-shaped. In some embodiments, normal vectors of the first magnetically permeable element 1510 and the second magnetically permeable element 1520 may be perpendicular to a first direction (e.g. the Z direction).

In some embodiments, a first magnetic force may be generated between the first magnetic element 1311 and the first magnetically permeable element 1510, a second magnetic force may be generated between the second magnetic element 1312 and the first guiding element 1410, a third magnetic force may be generated between the third magnetic element 1313 and the second magnetically permeable element 1520, and a fourth magnetic force may be generated between the fourth magnetic element 1314 and the second guiding element 1420, such as attractive forces between the elements, and the forces are applied on the movable portion 1200. For example, the direction of the first magnetic force may be the direction from the first magnetic element 1311 to the first magnetically permeable element 1510, the direction of the second magnetic force may be the direction from the second magnetic element 1312 to the first guiding element 1410, the direction of the third magnetic force may be the direction from the third magnetic element 1313 to the second magnetically permeable element 1520, and the direction of the fourth magnetic force may be the direction from the fourth magnetic element 1314 to the second guiding element 1420. In other words, the directions of the first magnetic force and the third magnetic force may be substantially opposite from each other, and the directions of the second magnetic force and the fourth magnetic force may be substantially opposite from each other.

It should be noted that the first magnetic force may generate a first torque to the movable portion 1200, the second magnetic force may generate a second torque to the movable portion 1200, the third magnetic force may generate a third torque to the movable portion 1200, the fourth magnetic force may generate a fourth torque to the movable portion 1200, such as torques taking the main axis 1900 as the rotational axis. Moreover, the first torque, the second torque, the third torque, and the fourth torque may have an identical direction, such as being clockwise in FIG. 1D. Therefore, normal forces relative to the first guiding element 1410 and the second guiding element 1420 may be provided to the movable portion 1200, so the movable portion 1200 may be disposed on the first guiding element 1410 and the second guiding element 1420 by frictional contact. When the force provided by the magnetic element 1310 and the driving coil 1320 is greater than the maximum frictional force between the movable portion 1200 and the first guiding element 1410 and the second guiding element 1420, the movable portion 1200 may move relative to the fixed portion 1100 in the Z direction. When the force provided by the magnetic element 1310 and the driving coil 1320 is less than the maximum frictional force between the movable portion 1200 and the first guiding element 1410 and the second guiding element 1420, the movable portion 1200 may stop at specific positions relative to the fixed portion 1100, such as may be used for performing focus.

By providing the first magnetically permeable element 1510 and the second magnetically permeable element 1520, the torques received by the movable portion 1200 may be further increased to increase the frictional force between the movable portion 1200 and the first guiding element 1410 and the second guiding element 1420, so the movable portion 1200 may be prevented from moving when the optical element driving mechanism 1000 being impacted.

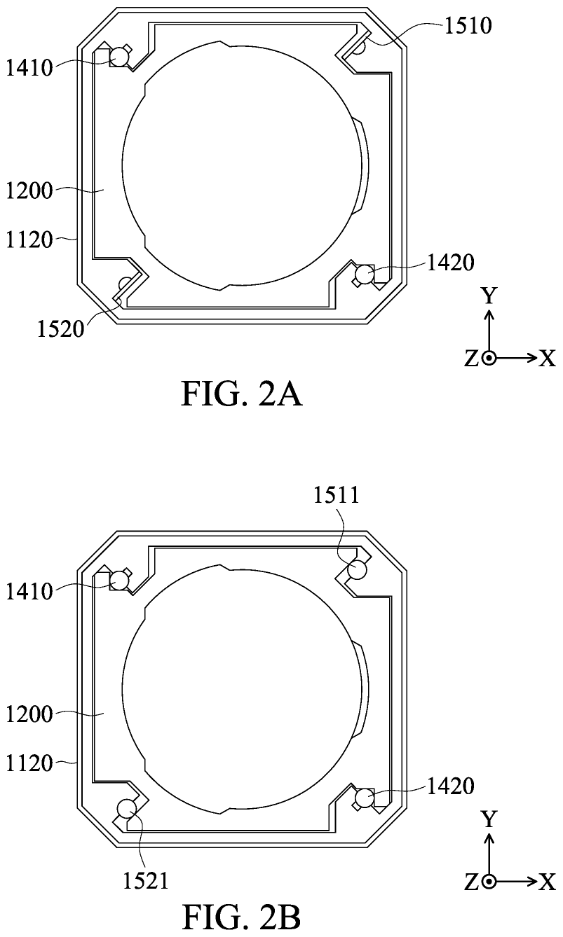

In some embodiments, different configurations of the magnetically permeable elements may be utilized. For example, FIG. 2A and FIG. 2B are top views of some elements of the optical element driving mechanism. As shown in FIG. 2A and FIG. 2B, the plate-shaped first magnetically permeable element 1510 and second magnetically permeable element 1520 may be replaced by columnar first magnetically permeable element 1511 and second magnetically permeable element 1521, and the first magnetically permeable element 1511 and the second magnetically permeable element 1521 may be affixed on the bottom 1120 and may be in frictional contact with the movable portion 1200 to achieve similar functions as the first guiding element 1410 and the second guiding element 1420.

In some embodiments, the circuit element 1600 may be a printed circuit board (PCB) and may be disposed on the fixed portion 1100 (e.g. the bottom 1120) to electrically connect to elements in the optical element driving mechanism 1000 and other devices outside the optical element driving mechanism 1000. For example, the circuit element 1600 may be disposed on four sides of the bottom 1120, such as by adhesion, but it is not limited thereto. In some embodiments, the first driving coil 1321, the second driving coil 1322, the third driving coil 1323, and the fourth driving coil 1324 may be disposed on the circuit element 1600 to allow external signal being transmitted to the first driving coil 1321, the second driving coil 1322, the third driving coil 1323, and the fourth driving coil 1324 to control the first driving coil 1321, the second driving coil 1322, the third driving coil 1323, and the fourth driving coil 1324.

In some embodiments, numbers of the elements in the magnetic element 1310, the driving coil 1320, the guiding assembly 1400, and the magnetically permeable assembly 1500 may be changed, but the sum of the elements of the guiding assembly 1400 and the magnetically permeable assembly 1500 (e.g. 2 guiding elements plus 2 magnetically permeable elements in this embodiments, totally 4 elements) may be equal to the numbers of the elements of the magnetic element 1310 or the driving coil 1320. Therefore, each of the magnetic element 1310 may be allowed to correspond to the guiding assembly 1400 or the magnetically permeable assembly 1500.

In some embodiments, the bottom 1120 may be polygonal, such as may include a first corner 1121, a second corner 1122, a third corner 1123, and a fourth corner 1124. The first corner 1121 and the third corner 1123 are opposite, and the second corner 1122 and the fourth corner 1124 are opposite. The first guiding element 1410 may be disposed on the first corner 1121, the second magnetically permeable element 1520 may be disposed on the second corner 1122, the second guiding element 1420 may be disposed on the third corner 1123, and the second magnetically permeable element 1520 may be disposed on the fourth corner 1124. Therefore, spaces at the corners of the optical element driving mechanism 1000 may be further utilized to achieve miniaturization.

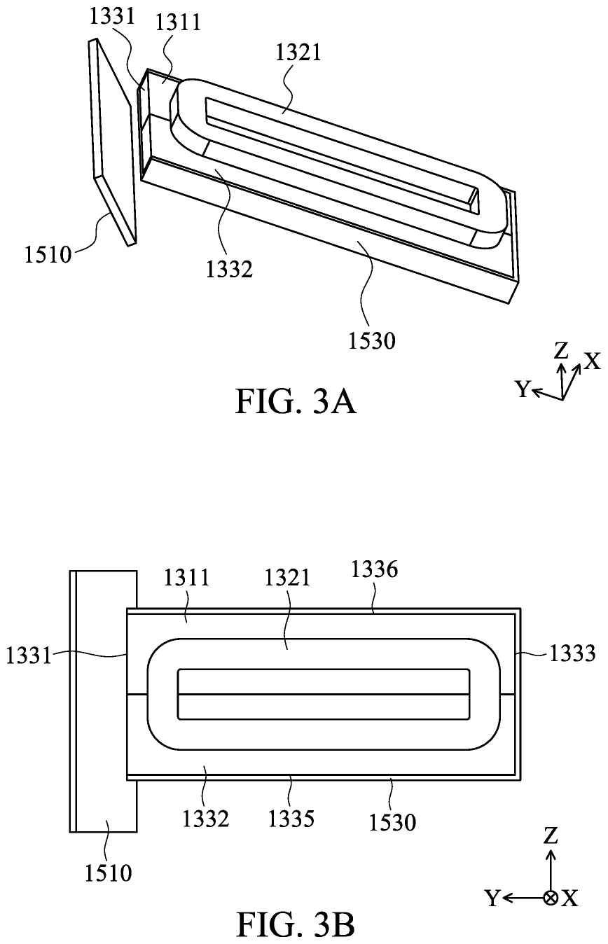

FIG. 3A, FIG. 3B, and FIG. 3C are schematic views of some elements of the optical element driving mechanism 1000 viewed in different directions, wherein elements adjacent to the first magnetically permeable element 1510 are mainly shown. As shown in FIG. 3A to FIG. 3C, the first magnetic element 1311 may have a first surface 1331, a second surface 1332, a third surface 1333, a fourth surface 1334, a fifth surface 1335, and a sixth surface 1336. The first surface 1331 may face the first magnetically permeable element 1510, the second surface 1332 may face the first driving coil 1321, the third surface 1333 and the first surface 1331 may be opposite, and the fourth surface 1334 and the second surface 1332 may be opposite. The fifth surface 1335 and the sixth surface 1336 may adjacent to the first surface 1331, the second surface 1332, the third surface 1333, and the fourth surface 1334. The fifth surface 1335 and the sixth surface 1336 may be opposite.

In some embodiments, the third magnetically permeable element 1530 may be disposed on the third surface 1333, the fourth surface 1334, the fifth surface 1335, and the sixth surface 1336, and it is not disposed on the first surface 1331 and the second surface 1332. In other words, the first surface 1331 and the second surface 1332 may be exposed from the third magnetically permeable element 1530. Therefore, the magnetic line of force of the first magnetic element 1311 may be concentrated on the first surface 1331 and the second surface 1332 to increase the force between the first magnetic element 1311, the first driving coil 1321, and the first magnetically permeable element 1510.

In some embodiments, as shown in FIG. 3B, when viewed in a direction perpendicular to the second surface 1332, at least a portion of the first magnetic element 1311 overlaps the first magnetically permeable element 1510 to reduce size in other directions to achieve miniaturization.

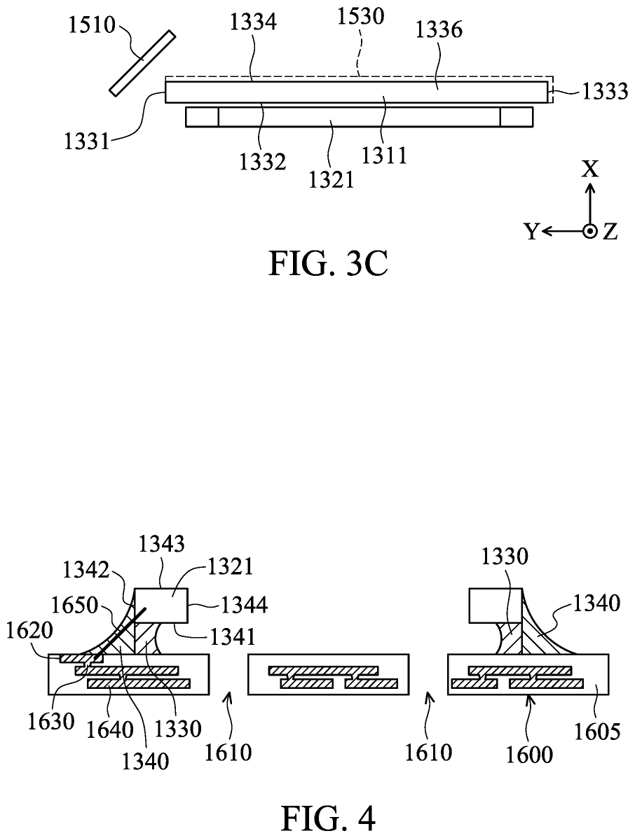

FIG. 4 is a schematic view of some elements of the optical element driving mechanism 1000, which mainly shows the circuit element 1600 and elements nearby. As shown in FIG. 1D and FIG. 4, the optical element driving mechanism 1000 may further include a first bonding element 1330 and a second bonding element 1340 to dispose the driving coil 1320 (which takes the first driving coil 1321 as an example later) on the circuit element 1600.

In some embodiments, the first bonding element 1330 may be disposed between the first driving coil 1321 and the circuit element 1600, and then dispose the second bonding element 1340, and the first bonding element 1330 and the second bonding element 1340 may be in direct contact with each other. In particular, the first driving coil 1321 may include, for example, a first coil surface 1341, a second coil surface 1342, a third coil surface 1343, and a fourth coil surface 1344. The first coil surface 1341 may be a surface facing the circuit element 1600. The second coil surface 1342 may be adjacent to the first coil surface 1341, such as an outer surface of the first driving coil 1321. The third coil surface 1343 may be opposite to the first coil surface 1341, and the fourth coil surface 1344 may be opposite to the second coil surface 1342. In some embodiments, the first bonding element 1330 may be disposed on the first coil surface 1341, such as cover a portion of the first coil surface 1341, and another portion of the first coil surface 1341 may be exposed. The second bonding element 1340 may cover at least a portion of the second coil surface 1342.

However, the present disclosure is not limited thereto. For example, in some embodiments, the first bonding element 1330 may cover the entire first coil surface 1341. In some embodiments, the first bonding element 1330 may further cover at least a portion of the second coil surface 1342. In some embodiments, the second bonding element 1340 may cover at least a portion of the first coil surface 1341. In some embodiments, the second bonding element 1340 may cover the entire second coil surface 1342, depending on design requirement. In some embodiments, the first bonding element 1330 and the second bonding element 1340 do not cover the third coil surface 1343 and the fourth coil surface 1344.

In some embodiments, the circuit element 1600 may include a main body 1605, a conductive pad 1620, a conductive via 1630, and a circuit 1640. The conductive pad 1620 may electrically connected to the circuit 1640 through the conductive via 1630. The conductive pad 1620 may be disposed on a surface of the main body 1605, and the conductive via 1630 and the circuit 1640 may be disposed in the main body 1605. In some embodiments, the first driving coil 1321 may include a leading wire 1650 electrically connected to the first driving coil 1321 and the conductive pad 1620. Therefore, external signal may be transmitted to the first driving coil 1321 through the circuit element 1600 and the leading wire 1650. The second bonding element 1340 may cover at least a portion of the conductive pad 1620 and the leading wire 1650 to protect the conductive pad 1620 and the leading wire 1650, and the first bonding element 1330 does not cover the conductive pad 1620 and the leading wire 1650. Therefore, the first driving coil 1321 may be disposed on the circuit element 1600 through the first bonding element 1330 in advance, and then the leading wire 1650 is bonded to the conductive pad 1620 (such as by soldering). Finally, the second bonding element 1340 is disposed thereon to protect the conductive pad 1620 and the leading wire 1650.

In some embodiments, the first bonding element 1330 may include, for example, thermosetting adhesive to affix the first driving coil 1321 on the circuit element 1600. The second bonding element 1340 may include, for example, photo-curable adhesive to temporarily bond the first driving coil 1321 on the circuit element 1600. In other words, the first bonding element 1330 and the second bonding element 1340 may include different materials.

In some embodiments, the circuit element 1600 may have a plurality of opening 1610 to define the position of the circuit element 1600. To increase the accuracy of positioning, the first bonding element 1330 and the second bonding element 1340 are not disposed on the opening 1610.

In summary, an optical element driving mechanism is provided. The optical element driving mechanism includes a movable portion used for connecting an optical element, a fixed portion, and a driving assembly used for driving the movable portion to move relative to the fixed portion. The movable portion is movable relative to the fixed portion. Therefore, auto focus may be performed, the position of the movable portion may be stabilized, and miniaturization may be achieved.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. An optical element driving mechanism, comprising:
a movable portion used for connecting an optical element;
a fixed portion, wherein the movable portion is movable relative to the fixed portion; and
a driving assembly used for driving the movable portion to move relative to the fixed portion.

2. The optical element driving mechanism as claimed in claim 1, further comprising a guiding assembly and a magnetically permeable assembly;
wherein:
the driving assembly comprises a plurality of magnetic elements and a plurality of driving coils;
the guiding assembly comprises at least one guiding element;
the magnetically permeable assembly comprises at least one magnetically permeable element;
the guiding assembly is magnetically permeable;
the magnetically permeable assembly is magnetically permeable.

3. The optical element driving mechanism as claimed in claim 2, wherein:
a sum of a number of the guiding elements and a number of the magnetically permeable elements is identical to a number of the magnetic elements;
the sum of the numbers of the guiding elements and the numbers of the magnetically permeable elements is equal to a number of the driving coils.

4. The optical element driving mechanism as claimed in claim 3, wherein:
the at least one guiding element comprises a first guiding element and a second guiding element;
the at least one magnetically permeable element comprises a first magnetically permeable element and a second magnetically permeable element;
the fixed portion comprises a bottom;
the bottom is polygonal;
the bottom comprises a first corner, a second corner, a third corner, and a fourth corner;
the first corner and the third corner are opposite;
the second corner and the fourth corner are opposite;
the first guiding element is disposed on the first corner;
the first magnetically permeable element is disposed on the second corner;
the second guiding element is disposed on the third corner;
the second magnetically permeable element is disposed on the fourth corner.

5. The optical element driving mechanism as claimed in claim 4, wherein:
the first guiding element and the second guiding element are columnar;
the first magnetically permeable element and the second magnetically permeable element are plate-shaped;
the first guiding element and the second guiding element extend in a first direction;
a normal vector of the first magnetically permeable element is perpendicular to the first direction;
a normal vector of the second magnetically permeable element is perpendicular to the first direction.

6. The optical element driving mechanism as claimed in claim 5, wherein:
the first guiding element and the second guiding element are in direct contact with the movable portion;
the first magnetically permeable element and the second magnetically permeable element are separated from the movable portion.

7. The optical element driving mechanism as claimed in claim 6, wherein:
the magnetic elements comprise a first magnetic element;
the driving coils comprise a first driving coil;
the first magnetic element corresponds to the first driving coil;
the first magnetic element comprises a first surface and a second surface;
the first surface faces the first magnetically permeable element;
the second surface faces the first driving coil;
the optical element driving mechanism further comprises a third magnetically permeable element disposed on the first magnetic element;
the first surface is exposed from the third magnetically permeable element;
the second surface is exposed from the third magnetically permeable element.

8. The optical element driving mechanism as claimed in claim 7, wherein the first magnetic element and the first magnetically permeable element at least partially overlap each other when viewed in a direction perpendicular to the second surface.

9. The optical element driving mechanism as claimed in claim 8, wherein:
the first magnetic element further comprises a third surface, a fourth surface, a fifth surface, and a sixth surface;
the third surface is opposite to the first surface;
the fourth surface is opposite to the second surface;
the fifth surface is adjacent to the first surface, the second surface, the third surface, and the fourth surface;
the sixth surface is adjacent to the first surface, the second surface, the third surface, and the fourth surface;
the fifth surface is opposite to the sixth surface;
the third magnetically permeable element is disposed on the third surface;
the third magnetically permeable element is disposed on the fourth surface;
the third magnetically permeable element is disposed on the fifth surface;
the third magnetically permeable element is disposed on the sixth surface.

10. The optical element driving mechanism as claimed in claim 9, wherein at least a portion of the movable portion is disposed between the third magnetically permeable element and the first magnetic element.

11. The optical element driving mechanism as claimed in claim 10, further comprising a circuit element, a first bonding element, and a second bonding element;
wherein:
the driving coils are disposed on the circuit element through the first bonding element;
the driving coils are disposed on the circuit element through the second bonding element;
the first bonding element is in direct contact with the second bonding element;
the first bonding element and the second bonding element comprise different materials.

12. The optical element driving mechanism as claimed in claim 11, wherein:
the circuit element comprises an opening;
the first bonding element is not disposed on the opening;
the second bonding element is not disposed on the opening.

13. The optical element driving mechanism as claimed in claim 12, wherein:
the first driving coil comprises a first coil surface, a second coil surface, a third coil surface, and a fourth coil surface;
the first coil surface faces the circuit element;
the second coil surface is adjacent to the first coil surface;
the first bonding element covers at least a portion of the first coil surface;
the second bonding element covers at least a portion of the second coil surface;
the third coil surface is opposite to the first coil surface;
the second coil surface is opposite to the fourth coil surface.

14. The optical element driving mechanism as claimed in claim 13, wherein:
the first bonding element and the second bonding element are not disposed on the third coil surface;
the first bonding element and the second bonding element are not disposed on the fourth coil surface.

15. The optical element driving mechanism as claimed in claim 14, wherein:
the first driving coil comprises a leading wire;
the circuit element comprises a conductive pad;
the leading wire connects to the conductive pad;
the second bonding element covers at least a portion of the leading wire;
the second bonding element covers at least a portion of the conductive pad.

16. The optical element driving mechanism as claimed in claim 15, wherein:
the first bonding element does not cover the leading wire;
the first bonding element does not cover the conductive pad.

17. The optical element driving mechanism as claimed in claim 16, wherein:
the magnetic elements further comprise a second magnetic element, a third magnetic element, and a fourth magnetic element disposed on the movable portion;
the driving coils further comprise a second driving coil, a third driving coil and a fourth driving coil disposed on the fixed portion;
the second magnetic element corresponds to the second driving coil;
the third magnetic element corresponds to the third driving coil;
the fourth magnetic element corresponds to the fourth driving coil.

18. The optical element driving mechanism as claimed in claim 17, wherein:
a first magnetic force is generated between the first magnetic element and the first magnetically permeable element and applied on the movable portion;
a second magnetic force is generated between the second magnetic element and the first guiding element and applied on the movable portion;
a third magnetic force is generated between the third magnetic element and the second magnetically permeable element and applied on the movable portion;
a fourth magnetic force is generated between the fourth magnetic element and the second guiding element and applied on the movable portion;
the first magnetic force, the second magnetic force, the third magnetic force, and the fourth magnetic force have different directions.

19. The optical element driving mechanism as claimed in claim 18, wherein:
directions of the first magnetic force and the third magnetic force are opposite;
directions of the second magnetic force and the fourth magnetic force are opposite.

20. The optical element driving mechanism as claimed in claim 19, wherein:
the first magnetic force generates a first torque to the movable portion;
the second magnetic force generates a second torque to the movable portion;
the third magnetic force generates a third torque to the movable portion;
the fourth magnetic force generates a fourth torque to the movable portion;
directions of the first torque, the second torque, the third torque, and the fourth torque are identical.
